(19) United States
(12) Patent Application Publication
(10) Pub. No.: US 2026/0280310 A1
(43) Pub. Date: Sep. 17, 2026

(54) WIRELESS COMMUNICATION SYSTEM

(71) Applicant: HITACHI ASTEMO, LTD., Ibaraki (JP)

(72) Inventors: Takanori YAMAZOE, Tokyo (JP); Masahiro KAGEYAMA, Tokyo (JP); Yoshimi NOGUCHI, Tokyo (JP); Daiki KOMATSU, Tokyo (JP); Tetsuya SASAKI, Hitachinaka-shi, Ibaraki (JP); Hikaru MIURA, Hitachinaka-shi, Ibaraki (JP)

(21) Appl. No.: 18/873,076

(22) PCT Filed: May 16, 2023
(86) PCT No.: PCT/JP2023/018271

§ 371 Date: Dec. 9, 2024

(30) Foreign Application Priority Data
Jul. 6, 2022 (JP) 2022-109292

(51) Int. Cl. H02J 7/44; B60L 3/00; B60L 58/18; H02J 7/82; H02J 105/37

(52) U.S. Cl. CPC H02J 7/44; B60L 3/0084; B60L 3/0092; B60L 58/18; H02J 7/82; H02J 2105/37

(57) ABSTRACT

A wireless communication system built in a battery pack of a vehicle is provided. The wireless communication system includes: a battery management device including an antenna and a cable that each emit a first radio signal into space, the antenna and the cable each outputting a reception signal based on a second radio signal propagated through the space; and a plurality of battery data devices provided in one-to-one correspondence to a plurality of battery modules included in the battery pack, the battery data devices being capable of wirelessly communicating with the battery management device via the antenna or the cable. The battery management device attenuates or cuts off the reception signal from the cable when wirelessly communicating with the battery data device via the antenna.

### TECHNICAL FIELD

The present invention relates to a wireless communication system that performs wireless communication in a battery pack incorporated in a vehicle.

### BACKGROUND ART

A battery pack used for electric vehicles, such as electric cars and hybrid cars, includes a plurality of battery modules. Each battery module is composed of a plurality of single battery cells, such as lithium ion cells, that are connected in series or in series and parallel. In general, a battery pack for electric vehicles is equipped with a battery controller that performs charge/discharge control over each battery module. The battery controller measures the state of single battery cells included in each battery module, estimates the capacity of each single cell from the measurement results, and performs charge/discharge control over each battery module to prevent its overcharging and overdischarging.

For the above-described battery pack for electric vehicles, a battery controller of a wireless configuration has been proposed for weight reduction, cost reduction, an expanded degree of freedom of in-vehicle equipment layout, and the like. A battery controller of a wireless configuration, i.e., wireless battery controller includes, for example, a plurality of battery data devices (slaves) each of which is provided for the corresponding each battery module and measures a state of each single battery cell of the battery module, a battery management device (master) that receives and analyzes information transmitted from the plurality of slaves and that controls each battery module, and a plurality of wireless devices that carry out wireless communication between each slave and the master. Such a wireless battery controller offers advantages described above, but raises a possibility that a null point (point at which wireless power decreases extremely) may develop under the influence of multiple paths created by reflection from a metal or the like in the battery pack. Development of the null point brings a concern that normal wireless communication cannot be carried out between the slave and the master present at the null point.

As a background technique in this technical field, PTL 1 discloses a method of using a leaky coaxial cable and an antenna together in wireless communication and improving reception performance by causing the leaky coaxial cable and the antenna to work according to a space diversity method.

### CITATION LIST

### Patent Literature

PTL 1: JP 2011-146909 A

### SUMMARY OF INVENTION

### Technical Problem

When the invention described in PTL 1 is applied to wireless communication in a battery pack, a sufficient distance cannot be provided between the leaky coaxial cable and the antenna, in which case the effects of the space diversity method may end up in insufficient.

The present invention has been conceived in view of the above-described problem of the conventional technique. A main object of the present invention is to establish stable wireless communication in a battery pack.

### Solution to Problem

A wireless communication system according to a first aspect of the present invention is built in a battery pack of a vehicle. The wireless communication system includes: a battery management device including an antenna and a cable that each emit a first radio signal into space, the antenna and the cable each outputting a reception signal based on a second radio signal propagated through the space; and a plurality of battery data devices provided in one-to-one correspondence to a plurality of battery modules included in the battery pack, the battery data devices being capable of wirelessly communicating with the battery management device via the antenna or the cable. The battery management device attenuates or cuts off the reception signal from the cable when wirelessly communicating with the battery data device via the antenna.

A wireless communication system according to a second aspect of the present invention is built in a battery pack of a vehicle. The wireless communication system includes: a battery management device having a cable functioning as an antenna; and a plurality of battery data devices provided in one-to-one correspondence to a plurality of battery modules included in the battery pack, the battery data devices being capable of wirelessly communicating with the battery management device via the cable.

### Advantageous Effects of Invention

According to the present invention, stable wireless communication can be carried out in the battery pack.

### BRIEF DESCRIPTION OF DRAWINGS

FIG. 1 depicts an example of an overall configuration of a wireless communication system according to a first embodiment of the present invention.

FIG. 2 depicts a modification of the wireless communication system according to the first embodiment of the present invention.

FIG. 3 depicts an example of the structure of a cable.

FIG. 4 depicts an example of the overall structure of a conventional wireless communication system.

FIG. 5 depicts an example of communication timing during normal communication in the conventional wireless communication system.

FIG. 6 depicts an example of communication timing during abnormal communication in the conventional wireless communication system.

FIG. 7 depicts an example of communication timing in the wireless communication system of the present invention.

FIG. 8 is an explanatory diagram of radio signal interference that occurs between an antenna and a cable.

FIG. 9 is a flowchart showing an example of a setting procedure for communication means used by a battery management device.

FIG. 10 depicts an example of reception levels of transmission signals transmitted respectively from battery data devices.

FIG. 11 depicts a first arrangement example of the wireless communication system in the battery pack.

FIG. 12 depicts a second arrangement example of the wireless communication system in the battery pack.

FIG. 13 depicts an example of a configuration of a terminator according to the first embodiment of the present invention.

FIG. 14 depicts an example of an overall configuration of a wireless communication system according to a second embodiment of the present invention.

FIG. 15 depicts an example of an overall configuration of a wireless communication system according to a third embodiment of the present invention.

FIG. 16 depicts a modification of the wireless communication system according to the third embodiment of the present invention.

FIG. 17 depicts an example of a configuration of a terminator according to the third embodiment of the present invention.

### DESCRIPTION OF EMBODIMENTS

Embodiments of the present invention will hereinafter be described. The following embodiments will be described as examples in which a wireless communication system is built by applying the present invention in a battery controller that monitors a battery system used in a vehicle, such as an electric vehicle (BEV). It should be noted that the present invention can be applied not only to the battery system used in the BEV but applied widely also to battery systems used in other vehicles, such as plug-in hybrid electric vehicles (PHEV), hybrid electric vehicles (HEV), and railway vehicles, and to various power storage devices for applications different from applications requiring vehicular battery systems.

Each of the following embodiments will be described on the assumption that a power storage/discharge device treated as a minimum unit of control in the battery system is provided as a lithium ion battery having an operating voltage ranging, for example, from 2.5 V to 4.5 V. However, a device other than the lithium ion battery may also be used to make up the battery system, providing that the device can store and release electric charges. Any device may be used, providing that its state can be monitored and controlled, using the battery controller of the present invention, and that use of the device can be restricted when its state of charge (SOC) is too high (overcharging) or too low (overdischarging). In the following description, such devices are collectively referred to as single battery or single battery cell.

### First Embodiment

A first embodiment of the present invention will hereinafter be described with reference to drawings.

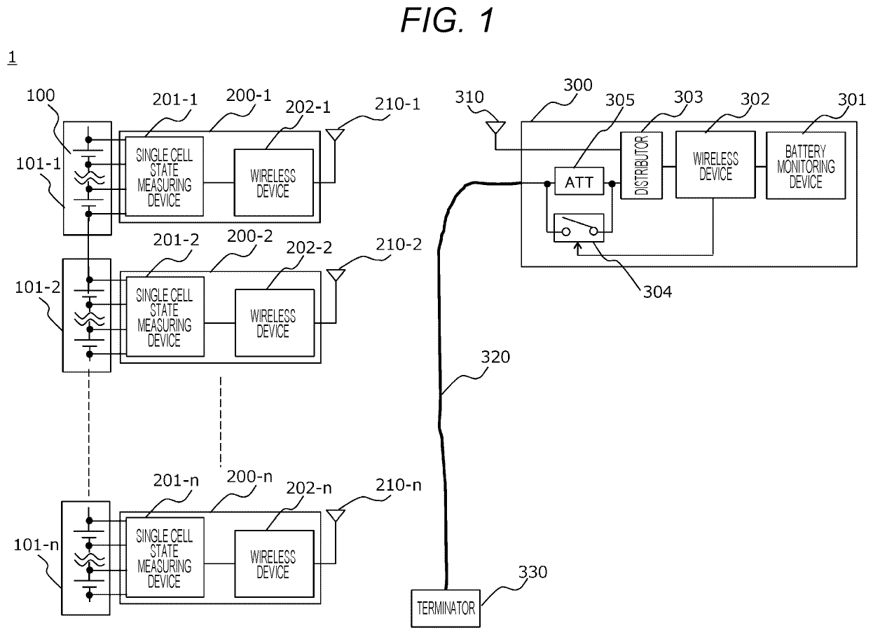

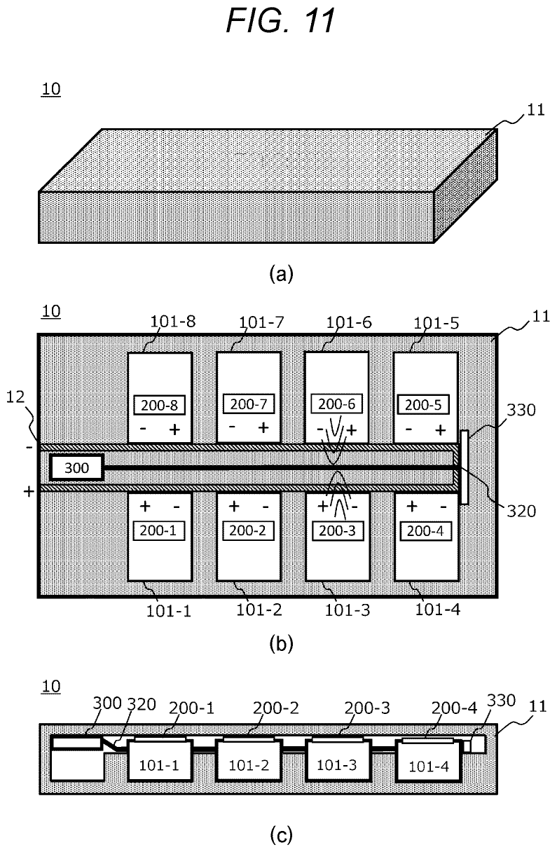

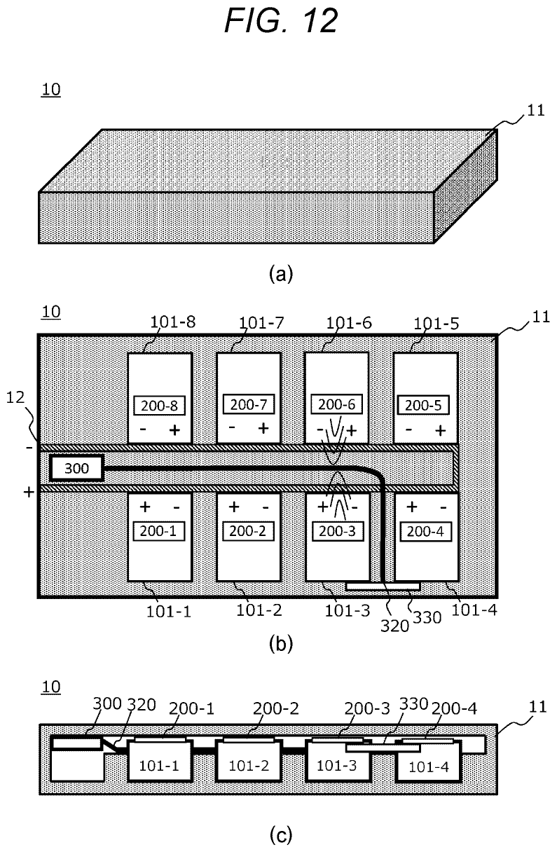

FIG. 1 depicts an example of an overall configuration of a wireless communication system according to the first embodiment of the present invention. A wireless communication system 1 shown in FIG. 1 is built in a battery pack 10 (see FIGS. 11 and 12) incorporated in a vehicle, and includes n (n denotes a positive natural number) battery data devices 200 and a battery management device 300. In FIG. 1, to distinguish the battery data devices 200 from other components, suffixes of 1 to n are appended to the tails of reference numerals for the battery data devices 200, respectively (e.g., battery data device 200-1).

The battery data devices 200 are connected respectively to n battery modules 101 included in the battery pack 10. In other words, the battery data devices 200 in the wireless communication system 1 are provided in one-to-one correspondence to the plurality of battery modules 101 included in the battery pack 10. Each battery module 101 is composed of a plurality of single battery cells 100 connected in series or in series and parallel. In FIG. 1, to distinguish the battery modules 101 from other components, suffixes of 1 to n are appended to the tails of reference numerals of the battery modules 101, respectively (e.g., battery module 101-1) in the same manner as in the case of the battery data devices 200.

Each battery data device 200 includes a single cell state measuring device 201, a wireless device 202, and an antenna 210. The single cell state measuring device 201 measures states of a plurality of single battery cells 100 included in the corresponding battery module 101, for example, measures voltages, temperatures, and the like of the single cells 100, and outputs the measurement results to the wireless device 202. The wireless device 202 modulates measurement data based on the measurement results outputted from the single cell state measuring device 201 to generate a transmission signal with a radio frequency, and outputs the transmission signal to the antenna 210. The antenna 210 emits a radio signal based on the transmission signal outputted from the wireless device 202, into space, thereby wirelessly transmitting the radio signal to the battery management device 300. In FIG. 1, the single cell state measuring device 201, the wireless device 202, and the antenna 210 that are included in each battery data device 200 each have the same suffix as appended to the battery data device 200 (e.g., single cell state measuring device 201-1, wireless device 202-1, and antenna 210-1).

The battery management device 300 includes a battery monitoring device 301, a wireless device 302, a distributor 303, a switch 304, an attenuator 305, an antenna 310, a cable 320, and a terminator 330. The antenna 310 receives a radio signal transmitted from each battery data device 200 and propagating through space to the antenna 310, and outputs a reception signal based on the radio signal to the wireless device 302. The cable 320 receives a radio signal transmitted from each battery data device 200 and propagating through space to the cable 320, and outputs a reception signal based on the radio signal to the wireless device 302, as the antenna 310 does. The cable 320 will be described in detail later.

The wireless device 302 demodulates the reception signal outputted from the antenna 310 or the cable 320 to generate measurement data indicating a state measurement result on each single battery cell 100 included in the battery module 101 corresponding to the battery data device 200 in one-to-one correspondence, and outputs the measurement data to the battery monitoring device 301. Based on the measurement data outputted from the wireless device 302, the battery monitoring device 301 acquires a state of each single battery cell 100 of the battery module 101 corresponding to the battery data device 200 in one-to-one correspondence. As a result, the battery management device 300 is able to acquire a state of each battery module 101 in the battery pack 10.

Once acquiring the state of each battery module 101, the battery monitoring device 301 generates, when necessary, a control signal for any one battery module 101 among the battery modules 101, the control signal controlling charging and discharging carried out by each single battery cell 100 included in the one battery module 101, and outputs the control signal to the wireless device 302. The wireless device 302 modulates the control signal outputted from the battery monitoring device 301 to generate a transmission signal with a radio frequency, and outputs the transmission signal to the antenna 310 and the cable 320. The antenna 310 and the cable 320 each emit a radio signal based on the transmission signal outputted from the wireless device 302, into space, and wirelessly transmit the radio signals to the battery data device 200. Hence wireless communication is carried out between each battery data device 200 and the battery management device 300 via the antenna 310 or the cable 320.

The antenna 310 and the cable 320 are connected to the wireless device 302 via the distributor 303. The distributor 303 transmits reception signals outputted respectively from the antenna 310 and the cable 320, to the wireless device 302, and distributes transmission signals outputted from the wireless device 302, to the antenna 310 and the cable 320.

The cable 320 is connected to the distributor 303 via a switch 304 and an attenuator 305. The attenuator 305 is a bidirectional attenuator that attenuates a radio-frequency signal by a given attenuation level (e.g., about several tens of dB). The switch 304 has its switching action controlled by the wireless device 302. When the switch 304 is switched to an off-state (open state), a reception signal outputted from the cable 320 is attenuated by the attenuator 305 and then is inputted to the wireless device 302 via the distributor 303. When the switch 304 is switched to an on-state (conductive state), the reception signal outputted from the cable 320 is not attenuated by the attenuator 305 and is inputted to the wireless device 302 via the switch 304 and the distributor 303. Switching control over the switch 304 by the wireless device 302 will be described later.

The terminator 330 is connected to a front end of the cable 320. The terminator 330 has impedance equal to input impedance of a transmission signal and to output impedance of a reception signal at the wireless device 302. Being connected to the cable 320 on the opposite side to the wireless device 302, this terminator 330 makes impedance matching between the cable 320 and the wireless device 302. Although the terminator 330 is included in the configuration of the wireless communication system 1 in FIG. 1, the terminator 330 may not be included in the wireless communication system 1.

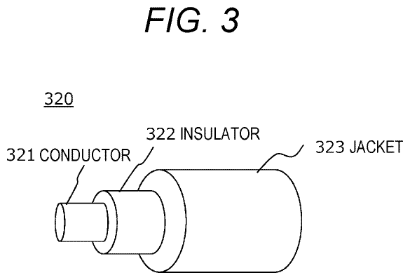

FIG. 3 depicts an example of the structure of the cable 320. As shown in FIG. 3, the cable 320 has a general cable structure in which a conductor 321 has its periphery covered with an insulator 322 whose periphery is covered with a jacket 323. In the cable 320, when a current flows through the conductor 321, the conductor 321 emits a radio signal to space around the conductor 321 and this radio signal propagating through the space around the conductor 321 generates a current flow in the conductor 321. The cable 320 thus functions as an antenna.

The structure of the cable 320 is not limited to the structure shown in FIG. 3. For example, a cable that functions as an antenna by letting a radio signal come in and go out of a conductor, such as a flexible board, may also be provided as the cable 320. In addition to this, a cable of any structure that functions as an antenna may be used as the cable 320.

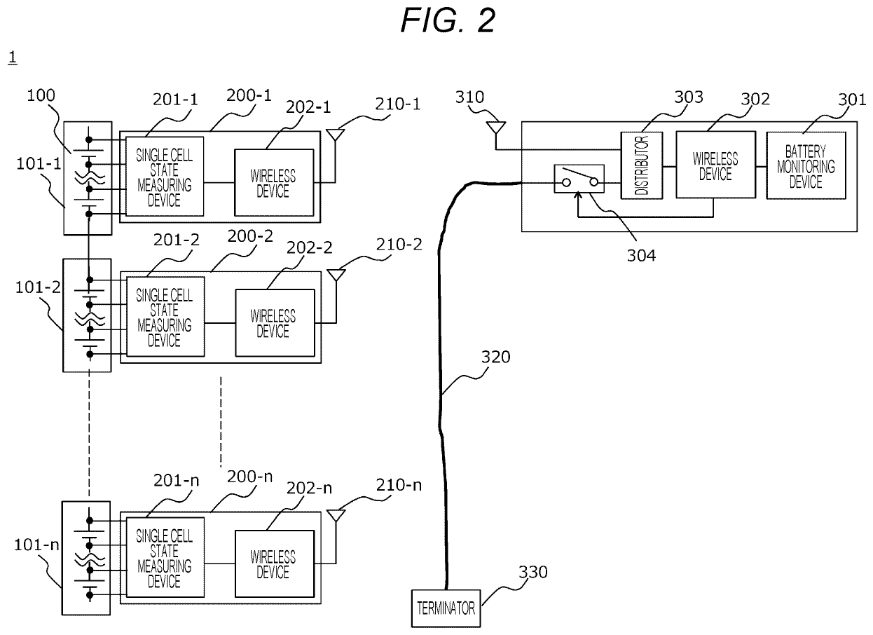

The example described above is the case where when the switch 304 of the battery management device 300 is switched to the off-state, the reception signal outputted from the cable 320 is attenuated by the attenuator 305 and is inputted to the wireless device 302. In the wireless communication system 1 shown in FIG. 1, however, output of the reception signal from the cable 320 to the wireless device 302 may be interrupted, for example, in a configuration shown in FIG. 2.

FIG. 2 depicts a modification of the wireless communication system according to the first embodiment of the present invention. According to the modification shown in FIG. 2, in the battery management device 300, the cable 320 is connected to the distributor 303 via the switch 304. When the switch 304 is switched to the open state, therefore, the reception signal outputted from the cable 320 is cut off and does not come into the wireless device 302. The battery management device 300 may be configured in this manner.

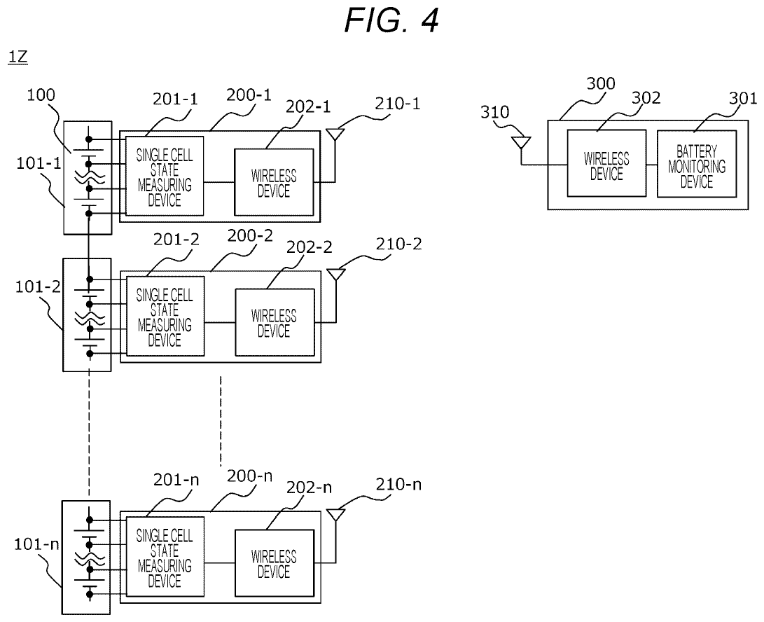

The operation of the wireless communication system of this embodiment will then be described through comparison with a conventional wireless communication system shown in FIG. 4. FIG. 4 depicts an example of the overall structure of the conventional wireless communication system. A wireless communication system 1Z shown in FIG. 4 is different from the wireless communication system 1 of the first embodiment of the present invention shown in FIGS. 1 and 2 in that the battery management device 300, which does not have the cable 320, carries out wireless communication with each battery data device 200 via the antenna 310 only.

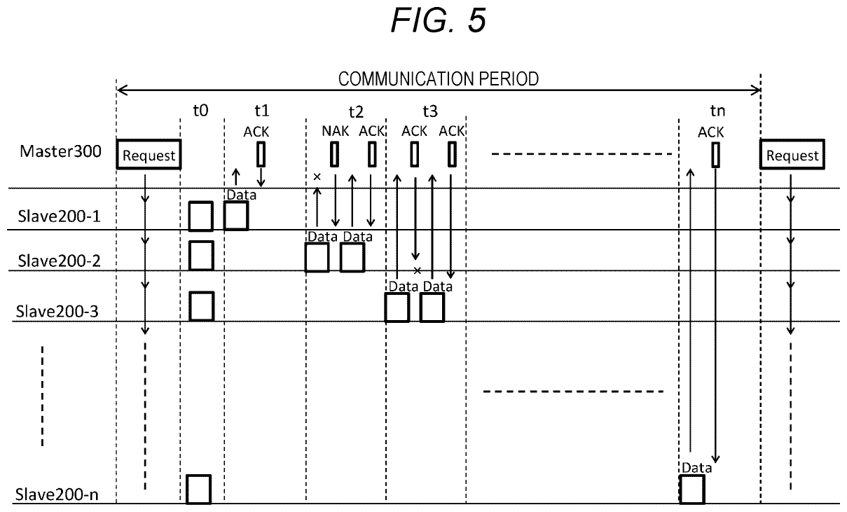

FIG. 5 depicts an example of communication timing during normal communication in the conventional wireless communication system 1Z shown in FIG. 4. In the wireless communication system 1Z, the battery management device 300 makes a request to each battery data device 200 for measurement of a state of the battery module 101, and in response to the request, each battery data device 200 makes measurement of the state of each battery module 101 and transmits the measurement results to the battery management device 300. Accordingly, in FIG. 5, operation timing of the battery management device 300 is expressed as “Master 300”, and operation timings of the battery data devices 200 are expressed as “Slave200-1”, “Slave200-2”, . . . , “Slave200 n”, respectively.

The battery management device 300 broadcasts a Request command to each battery data device 200. Upon receiving the Request command from the battery management device 300, each battery data device 200 measures, at time to, a state (voltage, temperature, etc.) of each single battery cell 100 of the battery module 101 corresponding to the battery data device 200. Thereafter, a battery data device 200-1 transmits, at time t1, data of the result of measurement of the state of each single battery cell 100 to the battery management device 300. When normally receiving the data transmitted from the battery data device 200-1, the battery management device 300 returns ACK to the battery data device 200-1.

In the same manner, at time t2, a battery data device 200-2 transmits data of the result of measurement of the state of each single battery cell 100 to the battery management device 300, and at time t3, a battery data device 200-3 do the same. In this manner, communication between each of the battery data devices 200 and the battery management device 300 is carried out in sequence until, at the time tn, the last battery data device 200-n transmits data of the result of measurement of the state of each single battery cell 100 to the battery management device 300.

Now a case is assumed where, at time t2, the battery management device 300 fails to normally receive data transmitted from the battery data device 200-2. In this case, the battery management device 300 returns NAK to the battery data device 200-2. Upon receiving the NAK, the battery data device 200-2 retransmits the data of the result of measurement of the state of each single battery cell 100 to the battery management device 300. When normally receiving the data retransmitted from the battery data device 200-2, the battery management device 300 returns ACK to the battery data device 200-2.

Another case is assumed where at time t3, a battery data device 200-3 transmits data to the battery management device 300, which normally receives the data and returns ACK, but the battery data device 200-3 fails to receive the ACK even after a given time has elapsed from transmission of the data. In this case, the battery data device 200-3 retransmits the data of the result of measurement of the state of each single battery cell 100 to the battery management device 300. When normally receiving again the data retransmitted from the battery data device 200-3, the battery management device 300 returns ACK to the battery data device 200-3. When normally receiving the ACK from the battery management device 300, the battery data device 200-3 ends data transmission.

In this manner, the battery management device 300 and each battery data device 200 repeat the above communication process during a communication period that lasts from the point of transmission of the Request command to time tn.

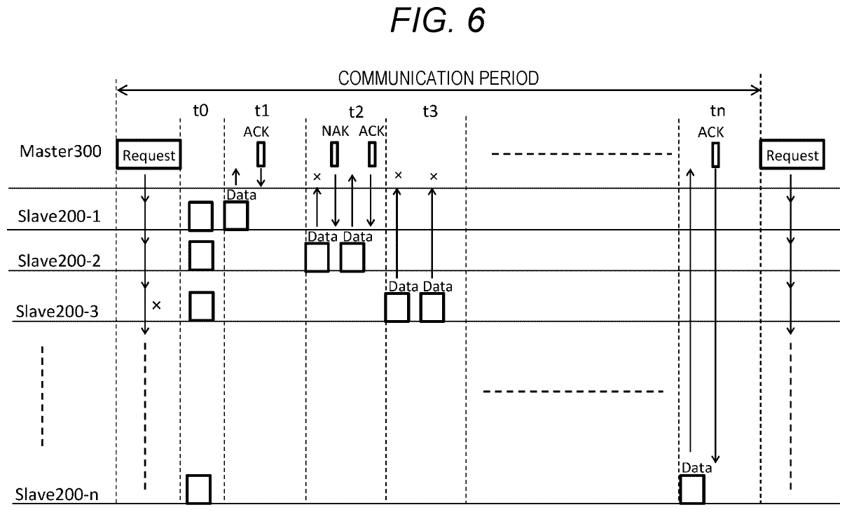

FIG. 6 depicts an example of communication timing during abnormal communication in the conventional wireless communication system 1Z shown in FIG. 4. FIG. 6 shows an example of a case where data transmitted from the battery data device 200-3 to the battery management device 300 cannot be normally received by the battery management device 300. In such a case, the battery management device 300 cannot acquire a state of a battery module 101-3, and therefore cannot perform normal charge/discharge control. When the battery data device 200-3 cannot receive a Request command from the battery management device 300, the battery data device 200-3 does not transmit data to the battery management device 300. In this case, as in the above case, the battery management device 300 cannot acquire the state of the battery module 101-3.

When a communication path between the battery management device 300 and the battery data device 200-3 is a null point created by multiple paths, a reception level for receiving transmission data from the battery data device 200-3 drops extremely at the battery management device 300. Likewise, a reception level for receiving a Request command transmitted from the battery management device 300 drops extremely at the battery data device 200-3. This may result in the above-described case where normal communication cannot be constantly carried out between the battery management device 300 and the battery data device 200-3. In general, the battery pack 10 contains numbers of arrays of metal parts, such as terminals of single battery cells 100 and various wires, and electric waves reflected on these metal parts create multiple paths, which inevitably leads to development of a null point.

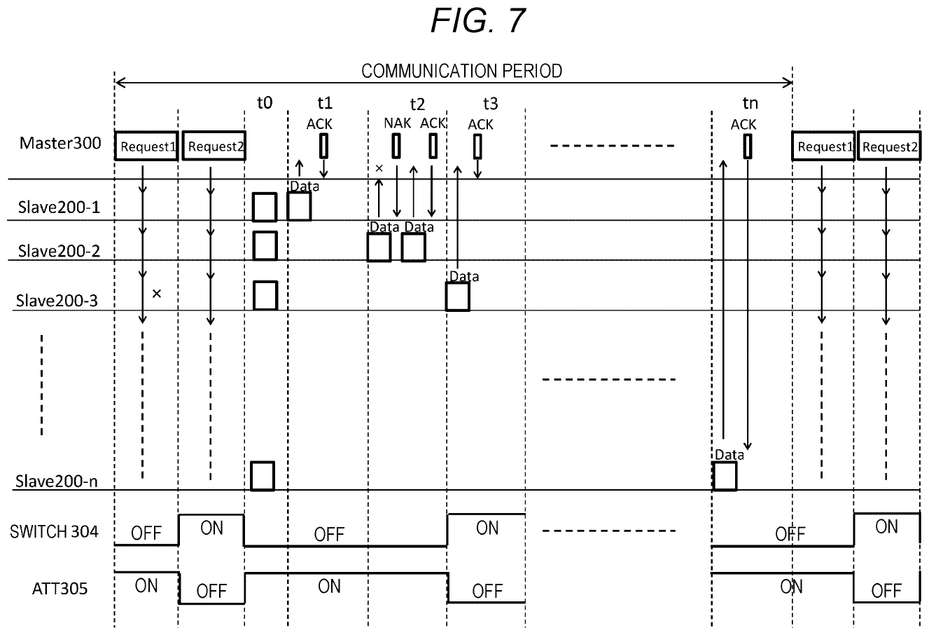

FIG. 7 depicts an example of communication timing in the wireless communication system of the present invention. In FIG. 7, the battery management device 300 has the configuration shown in FIG. 1, and the cable 320 of the battery management device 300 is disposed close to the battery data device 200 corresponding to the null point (the battery data device 200-3 in this example). For example, the distance between the cable 320 and the battery data device 200 is several tens of centimeters or less.

The battery management device 300 broadcasts a first Request command to each battery data device 200, except the battery data device 200-3, via the antenna 310. At this time, the wireless device 302 switches the switch 304 to the off-state so that the attenuator 305 is interposed between the cable 320 and the wireless device 302, thereby reducing the level of a transmission signal outputted from the wireless device 302 to the cable 320.

Subsequently, the battery management device 300 broadcasts a second Request command to the battery data device 200-3 via the cable 320, the battery data device 200-3 being the device to communicate with by wireless communication using the cable 320. At this time, the wireless device 302 switches the switch 304 to the on-state to bypass the attenuator 305 so that a transmission signal outputted from the wireless device 302 to the cable 320 is not attenuated.

Upon receiving the first Request command or the second Request command from the battery management device 300, each battery data device 200 measures a state (voltage, temperature, etc.) of each single battery cell 100 of the battery module 101 corresponding to the battery data device 200, at time to after standing by for a given time. Thereafter, a battery data device 200-1 transmits, at time t1, data of the result of measurement of the state of each single battery cell 100 to the battery management device 300. When normally receiving the data transmitted from the battery data device 200-1, the battery management device 300 returns ACK to the battery data device 200-1.

In the same manner, at time t2, a battery data device 200-2 transmits data of the result of measurement of the state of each single battery cell 100 to the battery management device 300, and at time t3, a battery data device 200-3 do the same. In this manner, communication between each of the battery data devices 200 and the battery management device 300 is carried out in sequence until, at the time tn, the last battery data device 200-n transmits data of the result of measurement of the state of each single battery cell 100 to the battery management device 300.

In this process, during a communication subperiod for communication with each battery data device 200 with which communication is made via the antenna 310, that is, a communication subperiod for communication with each of the battery data devices 200 except the battery data device 200-3 (in FIG. 7, each of communication subperiods of time t1 to time tn from which time t3 is excluded), the battery management device 300 switches the switch 304 off to interpose the attenuator 305 between the cable 320 and the wireless device 302, thus reducing the level of a reception signal outputted from the cable 320 to the wireless device 302. In contrast, in a communication subperiod (communication subperiod of time t3) for communication with the battery data device 200-3 with which communication is made via the cable 320, the switch 304 is switched on to bypass the attenuator 305 so that the reception signal outputted from the cable 320 to the wireless device 302 is not attenuated.

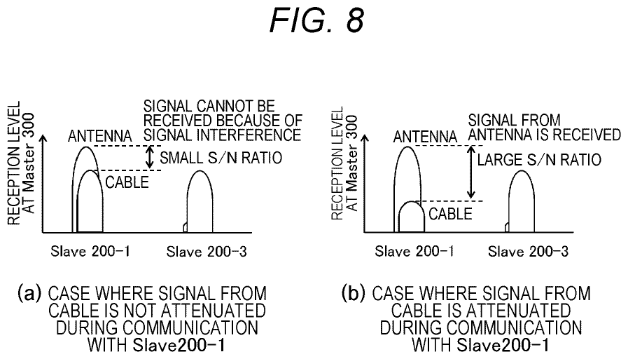

In the wireless communication system 1 of this embodiment, when the battery management device 300 communicates with each battery data device 200, the battery management device 300 switches the switch 304 on or off, depending on which of the antenna 310 and the cable 320 is used for communication, in the above manner. Thus, the attenuator 305 is interposed or not interposed between the cable 320 and the wireless device 302, depending on the switch 304 being on or off. This is done because during communication via the antenna 310, radio signal interference that occurs between the antenna 310 and the cable 320 needs to be suppressed. This matter will hereinafter be described with reference to FIG. 8.

FIG. 8 is an explanatory diagram of radio signal interference that occurs between the antenna 310 and the cable 320. FIG. 8 (a) shows an example of the level of a reception signal inputted to the wireless device 302 in a case where the battery management device 300 switches the switch 304 on to leave the reception signal from the cable 320 unattenuated during communication with the battery data device 200-1. FIG. 8 (a) shows also an example of the level of a reception signal in a case where the switch 304 is switched on as in the case of communication with the battery data device 200-1, the level of a reception signal being the level of a reception signal at the wireless device 302 during communication between the battery management device 300 and the battery data device 200-3.

In the case of FIG. 8 (a), during communication with the battery data device 200-1, reception signals coming from the antenna 310 and the cable 320 into the wireless device 302 interfere with each other, which makes a signal to noise (S/N) ratio smaller. As a result, the wireless device 302 is unable to normally receive the reception signal from antenna 310. In communication with the battery data device 200-3, on the other hand, because of a null point created by multiples paths, as described above, the reception level of the reception signal from the antenna 310 is low. This allows the wireless device 302 to normally receive the reception signal from the cable 320.

FIG. 8 (b) shows an example of the level of a reception signal inputted to the wireless device 302 in a case where the battery management device 300 switches the switch 304 off to attenuates the reception signal from the cable 320 during communication with the battery data device 200-1. As in FIG. 8 (a), FIG. 8 (b) shows also an example of the level of a reception signal in a case where the switch 304 is switched on, the level of a reception signal being the level of a reception signal at the wireless device 302 during communication between the battery management device 300 and the battery data device 200-3.

In the case of FIG. 8 (b), the reception signal inputted from the cable 320 to the wireless device 302 is attenuated during communication with the battery data device 200-1, and therefore the reception S/N ratio is larger than the reception S/N ratio in the case of FIG. 8 (a). As a result, the wireless device 302 is able to normally receive the reception signal from antenna 310. In communication with the battery data device 200-3, as in the case of FIG. 8 (a), the level of the reception signal from the antenna 310 remains low even when the switch 304 is switched on, and therefore the wireless device 302 is able to normally receive the reception signal from the cable 320.

As described above, during the communication subperiod for communication with each battery data device 200 using the antenna 310, the battery management device 300 switches the switch 304 off to attenuate signals inputted and outputted between the cable 320 and the wireless device 302. During the communication subperiod for communication with each battery data device 200 using the cable 320, on the other hand, the battery management device 300 switches the switch 304 on to prevent attenuation of signals inputted and outputted between the cable 320 and the wireless device 302. By such control of the switching actions of the switch 304, the battery management device 300 can suppress signal interference that occurs between the antenna 310 and the cable 320.

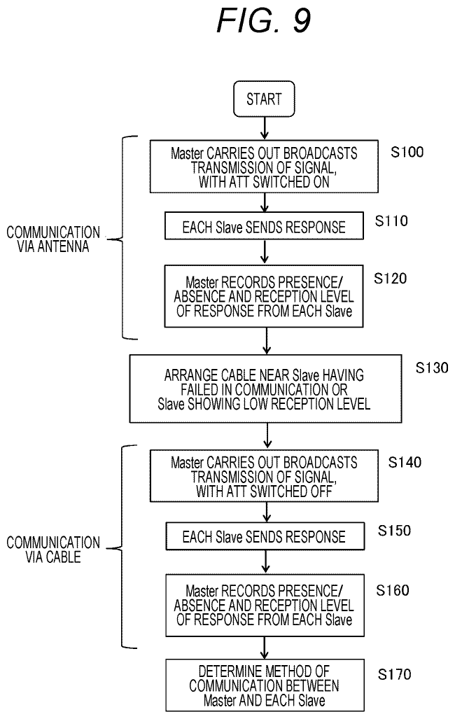

In the wireless communication system 1 of this embodiment, it is necessary to give the battery management device 300 preliminary setting by which the battery management device 300 determines which of the antenna 310 and the cable 320 is to be used for communication with each battery data device 200. A method of making this setting will hereinafter be described with reference to FIG. 9.

FIG. 9 is a flowchart showing an example of a setting procedure for communication means used by the battery management device 300. In the wireless communication system 1 of this embodiment, for example, at the time of manufacturing or prototyping of the battery pack 10, which of the antenna 310 and the cable 320 is used by the battery management device 300 in its communication with each battery data device 200 is set by the procedure according to the flowchart of FIG. 9.

The battery management device 300 switches the switch 304 off to interpose the attenuator 305 between the cable 320 and the wireless device 302, thereby attenuating a transmission signal outputted from the wireless device 302 to the cable 320 and broadcasting the attenuated transmission signal to each battery data device 200 (S100). When receiving the broadcasted transmission signal from the battery management device 300 at step S100, each battery data device 200 carries out data transmission in a given subperiod, as described with reference to FIG. 7 (S110). At step S110, the battery management device 300 receives data transmitted from each battery data device 200, and records the reception level of the data (S120).

After execution of processes of steps S100 to S120, a worker who manufactures the battery pack 10 and a designer who designs the battery pack 10 determine arrangement of the cable 320, based on the reception level of the transmission signal from each battery data device 200, the reception level being recorded at step S120 (S130). At this step, the arrangement of the cable 320 in the battery pack 10 is determined such that the cable 320 is disposed close to a battery data device 200 whose transmission signal has not been received at step S120 or has a reception level recorded as a level lower than a given value.

Subsequently, the battery management device 300 switches the switch 304 on to bypass the attenuator 305 between the cable 320 and the wireless device 302, thereby leaving a transmission signal outputted from the wireless device 302 to the cable 320 unattenuated and broadcasting the transmission signal to each battery data device 200 (S140). When receiving the broadcasted transmission signal from the battery management device 300 at step S140, each battery data device 200 carries out data transmission in a given subperiod in the same manner at step S110 (S150). At step S150, the battery management device 300 receives data transmitted from each battery data device 200, and records the reception level of the data (S160).

After execution of processes of steps S140 to S160, the worker and the designer determine a method of communication between the battery management device 300 and each battery data device 200, based on the reception level of the transmission signal from each battery data device 200, the reception level being recorded at steps S120 and S160 (S170). At this step, the method of communication between the battery management device 300 and each battery data device 200 is determined such that communication with a battery data device 200 whose transmission signal has been received normally at step S120 is carried out via the antenna 310 while communication with a battery data device 200 whose transmission signal has been not received normally at step S120 but has been received normally at step S160 is carried out via the cable 320. Then, by giving the wireless device 302 setting for the switching action of the switch 304 according to the determined communication method, setting according to the determined communication method is made on the battery management device 300.

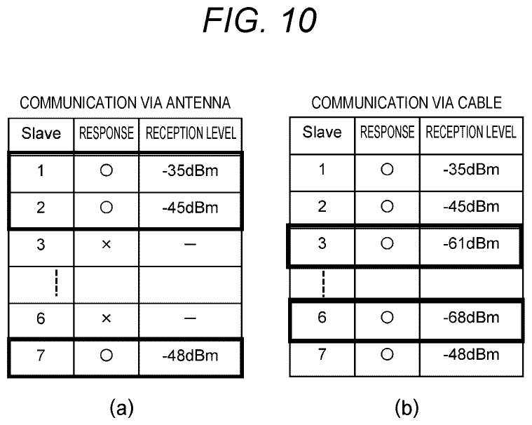

FIG. 10 depicts an example of reception levels of transmission signals transmitted respectively from the battery data devices 200, the reception levels being recorded at step S120 and step S160 of FIG. 9. FIG. 10(a) shows an example of reception levels resulting from communication via the antenna 310, the reception levels being recorded at step S120, and FIG. 10(b) shows an example of reception levels resulting from communication via the cable 320, the reception levels being recorded at step S160.

In FIG. 10(a), the reception levels at the battery data devices 200-3 and 200-6 among the battery data devices 200-1 to 200-7 are not recorded. This indicates that the transmission signals from the battery data devices 200-3 and 200-6 have been not normally received by the battery management device 300 under the influence of a null point or the like created by multiple paths.

In FIG. 10(b), on the other hand, the reception levels of the battery data devices 200-3 and 200-6 are recorded, as the reception levels of other battery data devices 200 are. This indicates that the transmission signals from the battery data devices 200-3 and 200-6 have been normally received by the battery management device 300 via the cable 320.

From the result of reception levels at the battery data devices 200 shown in FIG. 10, the operator or the designer can determine the communication means of the battery management device 300 in such a way as to use the antenna 310 for communication with the battery data devices 200-1, 200-2, 200-4, 200-5, and 200-7 and to use the cable 320 for communication with the battery data devices 200-3 and 200-6.

It should be noted that while the operation of the wireless communication system 1 has been described above with reference to FIGS. 7 to 10, based on the configuration of the battery management device 300 shown in FIG. 1, the operation of the wireless communication system 1 is the same in a case where the battery management device 300 has the configuration of FIG. 2. In this case, by switching the switch 304 to the off-state, the wireless device 302 cuts off a signal inputted and outputted between the wireless device 302 and the cable 320, instead of attenuating the signal.

A method of fixing the cable 320 in the battery pack 10 will then be described with reference to FIGS. 11 and 12.

FIG. 11 depicts a first arrangement example of the wireless communication system 1 in the battery pack 10. FIG. 12 depicts a second arrangement example of the wireless communication system 1 in the battery pack 10. In FIGS. 11 and 12, (a) is a perspective view of the battery pack 10, (b) is a plan view of the battery pack 10, and (c) is a front view of the battery pack 10.

As shown in FIGS. 11 and 12, the battery pack 10 has a case 11 of a large box shape. In this case 11, a plurality of the battery modules 101, a plurality of the battery data devices 200 paired respectively with the battery modules 101, and the battery management device 300. To make layout inside the battery pack 10 understandable, a part of the case 11 is not illustrated in the plan views of FIG. 11(b) and 12(b) and in the front views of FIG. 11(c) and 12(c).

The battery modules 101 are interconnected via a power supply line 12, and the cable 320 is disposed between parts of the power supply line 12. FIGS. 11 and 12 show an example in which the battery pack 10 includes eight battery modules 101 (battery modules 101-1 to 101-8) and eight battery data devices 200 (battery data devices 200-1 to 200-8) are provided in correspondence to the eight battery modules 101. The number of the battery modules 101 and of the battery data devices 200 is, however, not limited to eight.

A terminator 330 is connected to the cable 320. In each of the arrangement examples of FIGS. 11 and 12, the terminator 330 is placed in the battery pack 10 such that the width of the terminator 330 is larger than the arrangement interval of the battery modules 101 in the battery pack 10 and that a connection part connecting the cable 320 and the terminator 330 lies between two battery modules 101 adjacent to each other. Specifically, in the arrangement example of FIG. 11, the terminator 330 is placed such that the connection part connecting the cable 320 and the terminator 330 lies between the battery module 101-4 and the battery module 101-5, and in the arrangement example of FIG. 12, the terminator 330 is placed such that the connection part connecting the cable 320 and the terminator 330 lies between the battery module 101-3 and the battery module 101-4. In these arrangements, wireless communication between the battery management device 300 and the battery data device 200-3 and battery data device 200-6 can be carried out via the cable 320.

The arrangement examples of FIGS. 11 and 12 do not show the antenna 210 each battery data device 200 has and the antenna 310 the battery management device 300 has. These antennas can each be disposed at any given position in the battery pack 10.

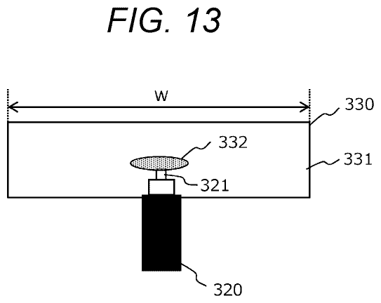

FIG. 13 depicts an example of a configuration of the terminator 330 according to the first embodiment of the present invention. In this embodiment, for example, the terminator 330 is constructed by connecting a conductor 321 of the cable 320 to a connection part 332 of a printed circuit board 331, using a bonding material, such as solder, as shown in FIG. 13. In addition to the connection part 332, various electronic components for input/output impedance adjustment can be mounted on the printed circuit board 331. As described above, the width w of the printed circuit board 331, the width w corresponding to the width of the terminator 330, is larger than the arrangement interval of the battery modules 101 in the battery pack 10. Because of this, placement of the terminator 330 in the battery pack 10 matches the placement of the same described above with reference to FIGS. 11 and 12, which allows the cable 320 to be fixed at an intended position.

The above-described first embodiment of the present invention offers the following effects.
(1) The wireless communication system 1 is constructed in the battery pack 10 of a vehicle. The wireless communication system 1 includes the battery management device 300 having the antenna 310 and the cable 320 that each emit a first radio signal into space, the antenna 310 and the cable 320 each outputting a reception signal based on a second radio signal propagated through the space; and the plurality of battery data devices 200 provided in one-to-one correspondence to the plurality of battery modules 101 included in the battery pack 10, the battery data devices 200 being capable of wirelessly communicating with the battery management device 300 via the antenna 310 or the cable 320. The battery management device 300 attenuates or cuts off the reception signal from the cable 320 by switching the switch 304 to the off-state when wirelessly communicating with the battery data device 200 via the antenna 310. As result, stable wireless communication can be carried out in the battery pack 10.
(2) The cable 320 has at least the conductor 321, and emits the first radio signal to an area around the conductor 321, based on a current flowing through the conductor 321. Because of this configuration, wireless communication via the cable 320 can be carried out.
(3) The battery management device 300 includes the terminator 330 connected to the front end of the cable 320. The width W of the terminator 330 is larger than the arrangement interval of the plurality of battery modules 101 in the battery pack 10, and the terminator 330 is placed in the battery pack 10 such that the connection part of the cable 320 lies between two battery modules 101 adjacent to each other among the plurality of battery modules 101. Because of this configuration, the cable 320 can be fixed certainly and easily at an intended position in the battery pack 10.
(4) The terminator 330 has the connection part 332 electrically connected to the cable 320. Because of this structure, the cable 320 and the terminator 330 can be electrically connected easily to allow the cable 320 to function as an antenna.

### Second Embodiment

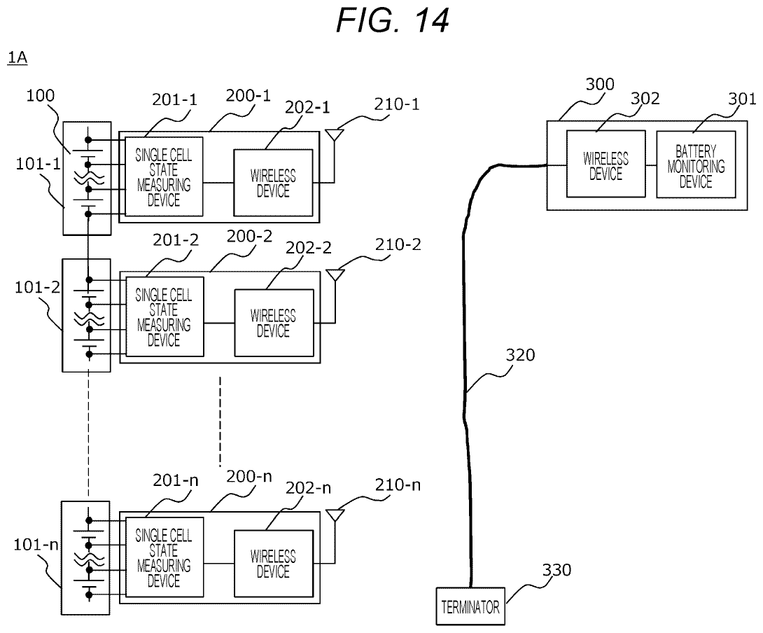

FIG. 14 depicts an example of an overall configuration of a wireless communication system according to a second embodiment of the present invention. A wireless communication system 1A shown in FIG. 14 is different from the wireless communication system 1 of FIGS. 1 and 2 described in the first embodiment in that the battery management device 300 does not include the antenna 310 and that the battery management device 300 communicates with each battery data device 200 through the cable 320 only.

In this embodiment, the battery management device 300 includes the battery monitoring device 301, the wireless device 302, antenna 310, the cable 320, and the terminator 330. Different from the first embodiment, the battery management device 300 of this embodiment is not provided with any one of the distributor 303, the switch 304, and the attenuator 305.

The cable 320 is disposed close to the battery data device 200 corresponding to the null point, as is in the first embodiment, Communication timing of communication between the battery management device 300 and each battery data device 200 is similar to the communication timing according to the first embodiment shown in FIG. 5, that is, the communication timing during normal communication by the conventional wireless communication system 1Z.

According to the second embodiment of the present invention described above, the wireless communication system 1A is constructed in the battery pack 10 of the vehicle, and includes the battery management device 300 having the cable 320 functioning as an antenna, and the plurality of battery data devices 200 provided in one-to-one correspondence to the plurality of battery modules 101 included in the battery pack 10, the battery data devices 200 being capable of wirelessly communicating with the battery management device 300 via the cable 320. Because of this configuration, stable wireless communication can be carried out in the battery pack 10 in the same manner as in the first embodiment.

### Third Embodiment

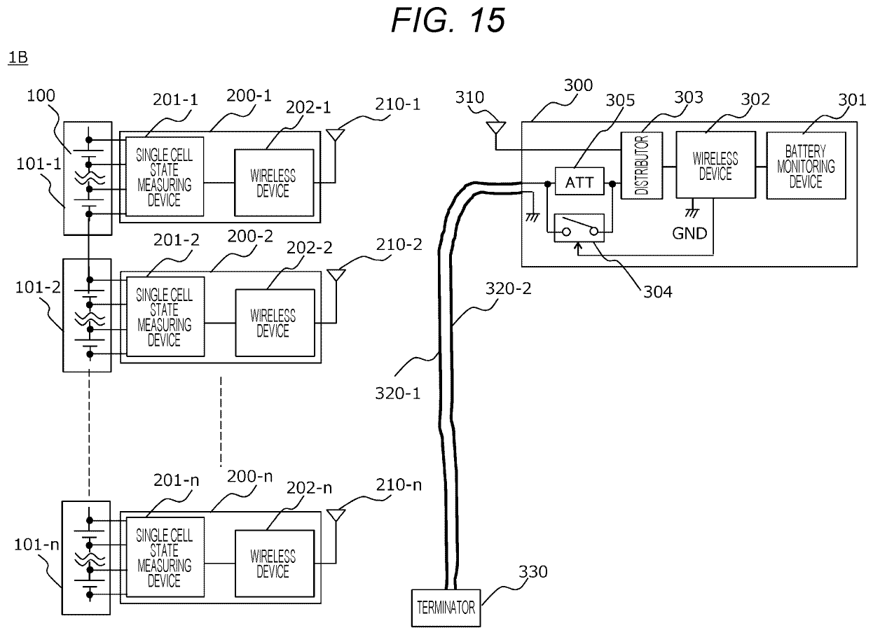

FIG. 15 depicts an example of an overall configuration of a wireless communication system according to a third embodiment of the present invention. The wireless communication system 1B shown in FIG. 15 is different from the wireless communication system 1 of FIG. 1 described in the first embodiment in that the battery management device 300 includes two cables 320-1 and 320-2.

Similarly to the cable 320 in the first embodiment, the cable 320-1 is connected to the wireless device 302 via the switch 304, the attenuator 305, and the distributor 303. When the switch 304 is switched to the off-state (open state), therefore, a reception signal outputted from the cable 320-1 is attenuated by the attenuator 305 and then is inputted to the wireless device 302 via the distributor 303. When the switch 304 is switched to the on-state (conductive state), the reception signal outputted from the cable 320-1 is not attenuated by the attenuator 305 and is inputted to the wireless device 302 via the switch 304 and the distributor 303.

The cable 320-2, which is a ground cable, is connected to a ground point of the battery management device 300. This ground point of is common to a ground point of the wireless device 302. In other words, the cable 320-2 is electrically connected to the ground point of the wireless device 302.

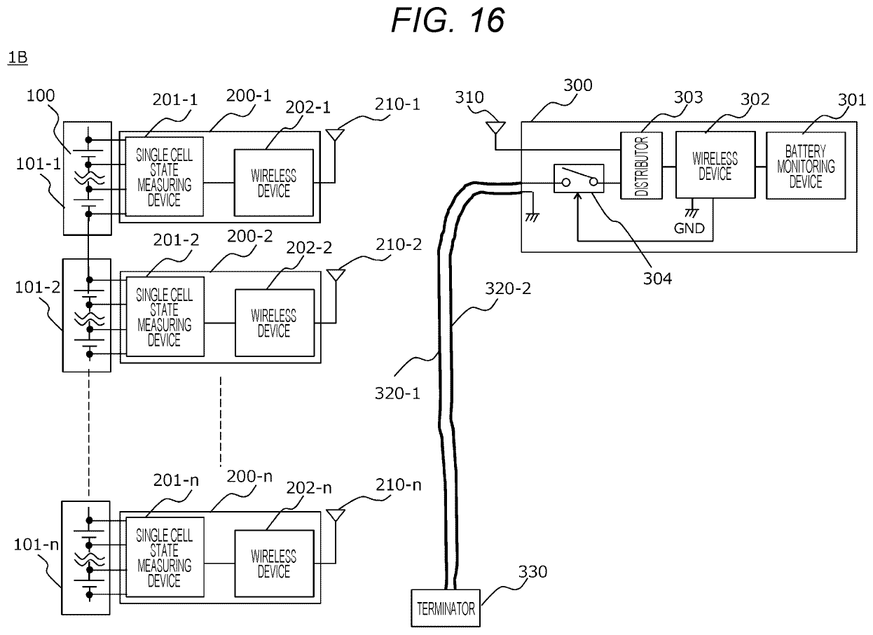

FIG. 16 depicts a modification of the wireless communication system according to the third embodiment of the present invention. In the modification shown in FIG. 16, the cable 320-1 is connected to the distributor 303 via the switch 304 in the battery management device 300 in the Same manner as the cable 320 is in the modification of the first embodiment.

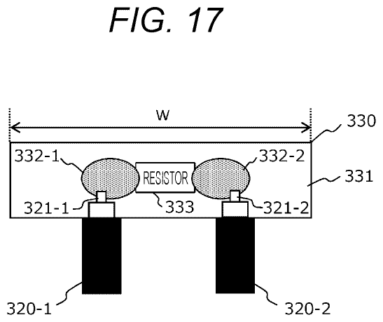

FIG. 17 depicts an example of a configuration of the terminator 330 according to the third embodiment of the present invention. In this embodiment, for example, the terminator 330 is constructed by connecting a conductor 321-1 of the cable 320-1 and a conductor 321-2 of the cable 320-2 to a connection part 332-1 and a connection part 332-2 of the printed circuit board 331, respectively, using a bonding material, such as solder, as shown in FIG. 17. The connection part 332-1 and the connection part 332-2 are connected to each other via a resistor 333 which is an impedance element. The impedance of the resistor 333 is equal to input impedance of a transmission signal and to output impedance of a reception signal at the wireless device 302. This suppresses a standing wave in the cable 320-1 to allow it to function reliably as an antenna.

According to the third embodiment of the present invention described above, the terminator 330 has the two connection parts 332-1 and 332-2 connected to each other via the resistor 333 that is the impedance element having the impedance equal to the input impedance of the reception signal at the battery management device 300. The connection part 332-1, which is one of the two connection parts, is

Electrically connected to the cable 320-1, while the connection part 332-2, which is the other of the two connection parts, is electrically connected to the ground point of the battery management device 300 via the cable 320-2, which is a ground cable. Because of this configuration, the cable 320-1 is able to function reliably as an antenna.

The embodiments and modifications described above are examples. Without being limited to these embodiments and modifications, the present invention may be implemented in other forms on condition that the features of the invention are not impaired. These embodiments and modifications have been described herein, but the present invention is not limited to the contents of the embodiments and modifications. Other modes that are conceived within the range of a technical concept of the present invention are also included in the scope of the present invention.

### REFERENCE SIGNS LIST

1, 1A, 1B wireless communication system
10 battery pack
11 case
12 power supply line
100 single battery cell
101 voltage module
200 battery data device (slave)
201 single cell state measuring device
202 wireless device
210 antenna
300 battery management device (master)
301 battery monitoring device
302 wireless device
303 distributor
304 switch
305 attenuator
310 antenna
320 cable
321 conductor
322 insulator
323 Jacket
330 terminator

1. A wireless communication system built in a battery pack of a vehicle, the wireless communication system comprising:
a battery management device including an antenna and a cable that each emit a first radio signal into space, the antenna and the cable each outputting a reception signal based on a second radio signal propagated through the space; and
a plurality of battery data devices provided in one-to-one correspondence to a plurality of battery modules included in the battery pack, the battery data devices being capable of wirelessly communicating with the battery management device via the antenna or the cable, wherein
the battery management device attenuates or cuts off the reception signal from the cable when wirelessly communicating with each of the battery data devices via the antenna.

2. The wireless communication system according to claim 1, wherein
the cable has at least a conductor, and emits the first radio signal to an area around the conductor, based on a current flowing through the conductor.

3. The wireless communication system according to claim 1, wherein
the battery management device includes a terminator connected to a front end of the cable, wherein
a width of the terminator is larger than an arrangement interval of the plurality of battery modules in the battery pack, and
the terminator is placed in the battery pack such that a connection part connected to the cable lies between two battery modules adjacent to each other among the plurality of battery modules.

4. The wireless communication system according to claim 3, wherein
the terminator has a connection part electrically connected to the cable.

5. The wireless communication system according to claim 3, wherein
the terminator has two connection parts connected to each other via an impedance element having impedance equal to input impedance of the reception signal in the battery management device,
one of the connection parts is electrically connected to the cable, and
the other of the connection parts is electrically connected to a ground point of the battery management device via a ground cable.

6. The wireless communication system according to claim 5, wherein
the cable and the ground cable each have a conductor, and
the cable emits the first radio signal to an area around the conductor, based on a current flowing through the conductor.

7. A wireless communication system built in a battery pack of a vehicle, the wireless communication system comprising:
a battery management device including a cable functioning as an antenna; and
a plurality of battery data devices provided in one-to-one correspondence to a plurality of battery modules included in the battery pack, the battery data devices wirelessly communicating with the battery management device via the cable.
